(19) United States
(12) Patent Application Publication
(10) Pub. No.: US 2015/0303612 A1
(43) Pub. Date: Oct. 22, 2015

(54) ELECTRICAL COUPLING DEVICE FOR A MACHINE

(71) Applicant: SCANIA CV AB, Södertälje (SE)

(72) Inventors: Jörgen ENGSTRÖM, Grödinge (SE); Mikael BERGQUIST, Huddinge (SE)

(73) Assignee: Scania CV AB, Södertälje (SE)

(21) Appl. No.: 14/648,954

(22) PCT Filed: Dec. 2, 2013
(86) PCT No.: PCT/SE2013/051423

§ 371 Date: Jun. 2, 2015

(30) Foreign Application Priority Data
Dec. 10, 2012 (SE) 1251397-4

(51) Int. Cl. H01R 13/52; H01R 13/42

(52) U.S. Cl. CPC H01R 13/5202; H01R 13/42

(57) ABSTRACT

An electrical connecting device for a machine includes a fitting element (2) to be fitted in an aperture (1a) of a wall element (1), at least one connecting element (3) which has a first end (3a) with a first connection unit (3b) for an electric cable which is situated outside the wall element (1), a second end (3c) with a second connecting element (3d) for an electric cable which is situated within the internal space, and an intermediate portion (3e) to be fitted in an aperture (2c) which runs through the fitting element (2); a sealing (5) makes a tight connection between the connecting element (3) and the fitting element (2) in the aperture (2c). The fitting element (2) is made integrally from a first material. The connecting element (3) is made integrally from a second material. The connecting element (3) and the fitting element (2) are provided with mutually cooperating surfaces (2c₁, 2c₂, 3e₁, 3e₂) which define a predetermined fitting position for the connecting element (3) in the aperture (2c).

### CROSS-REFERENCE TO RELATED APPLICATIONS

The present application is a 35 U.S.C. §§371 national phase conversion of PCT/SE2013/051423, filed Dec. 2, 2013, which claims priority of Swedish Patent Application No. 1251397-4, filed Dec. 10, 2012, the contents of which are incorporated by reference herein. The PCT International Application was published in the English language.

### BACKGROUND TO THE INVENTION AND PRIOR ART

The present invention relates to an electrical connecting device for a machine.

Electrical machines may be cooled by oil which is distributed freely within an internal space of the machine. Such an electrical machine may be situated in a hybrid vehicle in which it serves alternately as a motor and a generator. Electrical machines of this kind need a connecting device which transfers electrical energy between its stator windings situated within the oil-filled space and a source for storage of electrical energy situated outside the oil-filled space. The connecting device has an internal connection for electric cables which are connected to the electrical machine's stator windings and an external connection for electric cables which are connected to the energy storage source. The internal connection is suited to being in contact with oil, whereas the external connection needs to be kept dry and free from oil. Any oil reaching the external connection would make this part of the connecting device difficult to service. Oil also tends to creep in between the conductors and insulation of electric cables. The oil may thus reach the energy storage source and connecting electrical components via the electric cables and cause problems.

EP 1 541 831 refers to an electric motor and a pump situated in a housing which contains hydraulic oil. An electrical connecting device is situated in an aperture of the housing. The connecting device comprises a platelike element fastened in the housing.

The platelike element has three holes for respective contact pins made of electrically conductive material. Each contact pin is fitted on the platelike element by means of a screw-type portion and a nut. The threaded portion and the nut constitute a threaded connection which in a tightened state has also the function of providing a tight connection between the platelike element and the contact pin in the respective hole.

U.S. Pat. No. 7,494,362 refers to a connecting device for transfer of high voltage between an electric cable situated on the outside of a casing of an electric motor unit and an electric cable situated on the inside of the casing. The contact device comprises a connection unit situated in an aperture in the casing. The connection unit comprises a plurality of components, in particular an electrically conductive means, an internal casing and an external casing. The connection unit is provided with an O-ring which serves as a seal in the space between the hole and the connection unit. The connection unit has a threaded portion by means of which it is screwed firmly in a cuplike retainer fastened to the inside of the casing. Such a connecting device is of relatively complicated configuration.

### SUMMARY OF THE INVENTION

The object of the present invention is to propose an electrical connecting device for a machine, the device being of relatively simple configuration with few components and which at the same time provides a good seal and is easy to fit.

This object is achieved with the arrangement herein.

The fitting element is thus manufactured integrally from a first material which has, with advantage, good resistance to oil and also has with advantage electrically insulating characteristics. It may be a plastic material with the characteristics indicated above.

The connecting element is manufactured integrally from a second material which has good electrical conductive characteristics. The second material is appropriately a metal material, which may with advantage be brass. The connecting element and the fitting element are configured with mutually cooperating surfaces which define a predetermined fitting position for the connecting element positioned in the hole which runs through the fitting element. Such a solution makes it possible for the connecting element and the fitting element to be fitted in an intended firm fitting position relative to one another in which they are locked together by their shapes. This obviates any need to use separate components for fixing the connecting element and the fitting element in the intended fitting position relative to one another. If the electrical machine is oil-cooled, it is also important to prevent oil from leaking out via the hole which runs through the fitting element. It is therefore appropriate to provide a sealing means between the connecting element and the fitting element in the hole. Because the connecting element is kept in a fixed fitting position in the hole, there will be no relative movements between the connecting element and the fitting element, making it easier to achieve a tight connection with a sealing means. The connecting device according to the invention comprises a small number of components which can be manufactured at low cost. Few components also make the connecting device easy to assemble.

In one embodiment of the invention the fitting element and the connecting element have mutually cooperating surfaces which define a predetermined rotational position for the connecting element within the hole. Providing the intermediate portion of the connecting element and the hole which runs through the fitting element with matching cross-sectional shapes which are not circular in at least one region gives the connecting element a firm rotational position relative to the fitting element. Such a cross-sectional shape may with advantage be semicircular. A semicircular shape results in a planar surface of the connecting element being in contact with a planar surface which defines the hole. The result is two relatively large planar surfaces which ensure that the connecting element is kept in a desired rotational position.

In another embodiment of the invention the fitting element and the connecting element have mutually cooperating surfaces which define a predetermined axial fitting position for the connecting element within the hole. The fitting element is preferably provided with a hole running through it which has a region with a reduced cross-sectional shape. When the connecting element reaches this region, it will not be possible for it to be inserted further into the hole. The mutually cooperating stop surfaces are with advantage situated in a transitional region in which the fitting element and the connecting element change from a circular cross-section to a non-circular cross-section.

In another embodiment of the invention the sealing means is configured to being fitted in a recess which extends round the connecting element. Such a sealing means is with advantage an O-ring. O-rings are annular gaskets made of elastic material. When the connecting element with the O-ring is inserted in the hole, the O-ring is compressed, causing it to exert a pressure on the connecting element and the surfaces which define the hole. A suitably compressed O-ring provides a very good seal in the radial space between the connecting element and the surfaces which define the hole. A further advantage of an O-ring is that said compressive force counteracts any outward movement of the connecting element from the hole. Such a compressive force is often sufficient to keep the connecting element in the intended fitting position in the hole.

In another embodiment of the invention the intermediate portion of the connecting element comprises a region which has a circular cross-section and a region which has a non-circular cross-section. In this case an O-ring may be placed in a recess in the region which has the circular cross-section. The region of the intermediate portion which has the non-circular cross-section will keep the connecting element in a specific rotational position relative to the fitting element when the connecting element has reached the specific fitting position. Such an intermediate portion thus provides a firm rotational position for the connecting element relative to the fitting element while at the same time making it possible to fit an O-ring and achieve good sealing of the hole.

In another embodiment of the invention the ends of the connecting element have connection units in the form of threaded holes which may have an axial extent and have in an end surface at an end of the connecting element an aperture which has a circular cross-section. Each threaded hole may be provided with a radial extent and have in a planar surface at an end of the connecting element an aperture which has a circular cross-section. This makes it easy for an electric cable provided with a suitable cable lug to be screwed firmly into such a threaded hole at the ends of the connecting element by means of a screw. It is however possible to provide the connecting element with substantially any suitable kind of connection unit for electric cables.

In another embodiment of the invention the fitting element has running through it at least two holes to accommodate respective connecting elements. The fitting element preferably has running through it three holes to accommodate respective connecting elements in order to be able to transfer electric current in three phases. It is possible to use only one fitting element which has running through it a number of holes which corresponds to the number of electric cables which are to be connected in the connecting device.

In another embodiment of the invention the connecting element has a housing which encloses the first connection unit and the first end of the connecting element. The connecting components at the first end of the connecting element are thus provided with good protection from dirt, moisture and mechanical deformation. The housing has with advantage an openable or removable cover which may be fastened by screws or the like so as to be easy to remove, e.g. for servicing of the connecting device.

In another embodiment of the invention the housing and the fitting element are manufactured in the form of a composite unit. They may be made of different materials and thereafter be fastened together in a suitable way. They may for example be adhesively bonded together. The connecting element may thereafter be inserted in the hole to the specific fitting position. The connecting device may then be fitted as a unit in the aperture in the wall element. In this case, the connecting device will be very easy to fit.

### BRIEF DESCRIPTION OF THE DRAWINGS

Preferred embodiments of the inventions are described below by way of examples with reference to the attached drawings, in which

FIG. 1 depicts an electrical connecting device according to a first embodiment of the invention,

FIG. 2 depicts a vertical cross-section through the connecting device in FIG. 1 in a fitted state,

FIG. 3 depicts a horizontal cross-section through the connecting device in FIG. 1 in a fitted state and

FIG. 4 depicts an alternative embodiment of the connecting device.

### DETAILED DESCRIPTION OF PREFERRED EMBODIMENTS OF THE INVENTION

FIG. 1 depicts part of a wall element 1 of an electrical machine. The electrical machine is oil-cooled and the wall element defines a closed internal space which contains oil.

Such an electrical machine may be situated in a hybrid vehicle in which it serves alternately as a motor and a generator. An electrical connecting device is adapted to transferring electrical energy, via an aperture 1a in the wall element 1, between the electrical machine's windings (not shown) which are situated within the closed space and externally situated electric cables (not shown) which are connected to a hybrid energy store (not shown). The hybrid energy store may comprise a hybrid battery with associated electronic components. The electric cables which are connected to the connecting device, the electrical machine's windings and the hybrid energy store do not appear in drawings, since they do not form part of the connecting device.

The electrical connecting device comprises a fitting element 2 configured to being fitted in the aperture 1a in the wall element 1. The shape of the fitting element 2 corresponds to that of the aperture 1a so that it fully covers the aperture in the fitted state. The fitting element is made integrally from oil-resistant material with electrically insulating characteristics. The fitting element is with advantage made of plastic material which has these characteristics. The fitting element has a first side 2a suited to being located outside the wall element 1, and a second side 2b suited to being located inside the wall element 1. The fitting element has running through it three holes 2c suited to accommodating respective connecting elements 3 of the connecting device.

Each of the connecting elements 3 is made integrally from an electrically conductive material which may be brass. Each of them has a first end 3a which has a cylindrical shape and a circular cross-section. The first end 3a is provided with a connection unit in the form of a threaded axial hole 3b which has an aperture in an end surface of the first end 3a. An undepicted externally situated electric cable provided with a suitably shaped cable lug may be fastened to the end surface by means of a screw or the like. Each of the connecting elements 3 has a second end 3c which has a semicylindrical shape and a consequently semicircular cross-section. The second end 3c is provided with a connection unit in the form of a threaded radial hole 3d which has an aperture in a planar surface 3e₂. An undepicted internally situated electric cable provided with a suitably shaped cable lug may be fastened to the planar surface 3e₂ by means of a screw or the like. Each of the connecting elements 3 has an intermediate portion 3e suited to being situated within the hole 2c which runs through the fitting element when the connecting element 3 is in a fitted state. The intermediate portion 3e has a region with a circular cross-section and a region with a semicircular cross-section. The intermediate portion 3e has an annular depression 3f in the circular region to serve as a seat for a sealing means in the form of an O-ring 5. The region with semicircular cross-section comprises part of the planar surface 3e₂.

The electrical connecting device also comprises a housing 4 which has an internal space appropriate to enclosing the first end 3a and the first connection unit 3b of the connecting element 3 and connecting electric cable ends. The housing 4 has three holes 4a for leading in the electric cables which are to be connected to the connecting device in the housing. The holes 4a are provided with screw-type cable fittings for sealing and electrical screening connections. The housing is provided with a contact surface 4b appropriate to coming into contact with the wall element 1 in a fitted state. The housing is provided with holes 4c for screws or the like for fitting the housing to the wall element. The electrical connecting device thus comprises a fitting element 2, three connecting elements 3, a housing 4 and three O-rings 5.

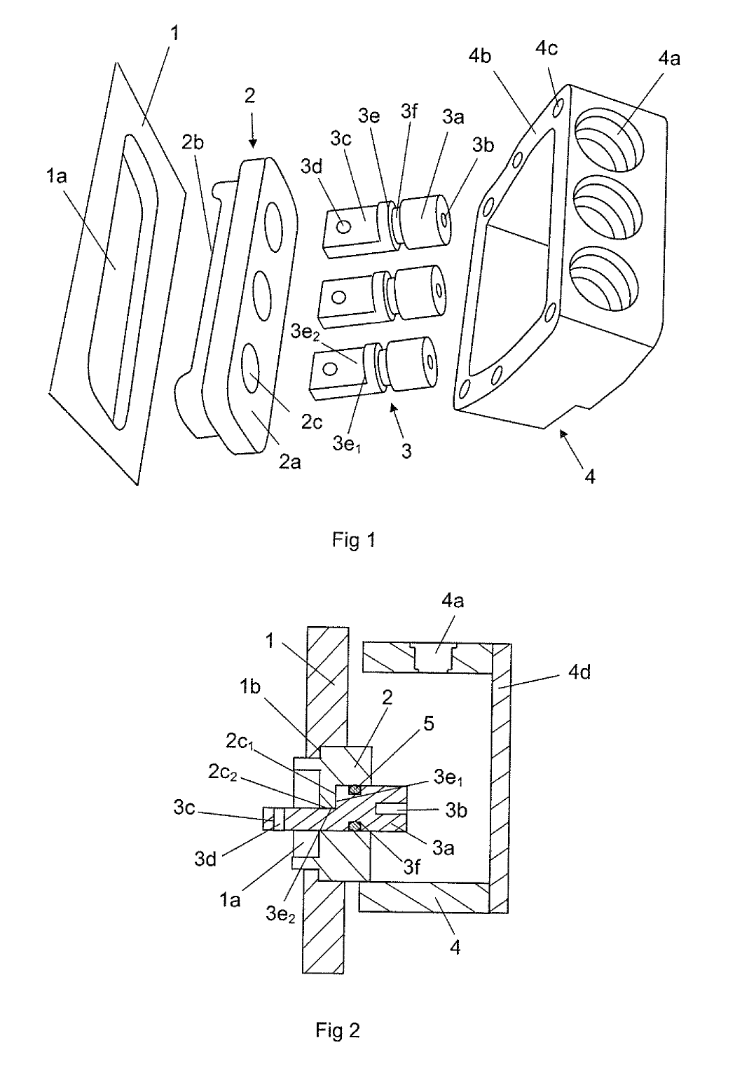

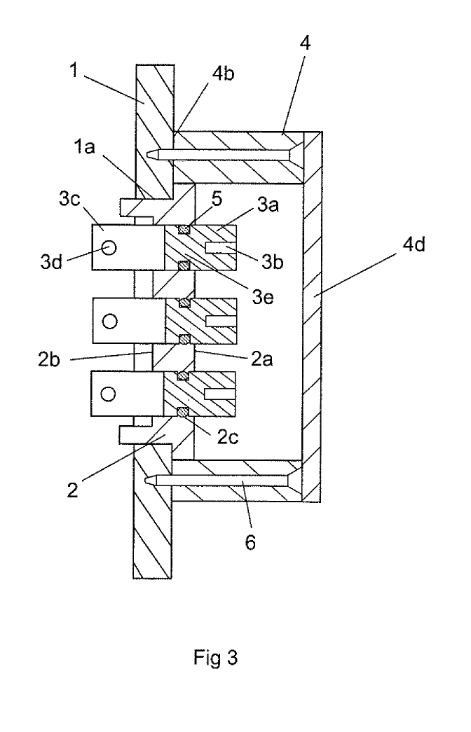

FIG. 2 is a cross-sectional view in a vertical plane through the connecting device when the latter is in a fitted state, and FIG. 3 is a section through the connecting device in a horizontal plane. It may be seen that the holes 2c running through the fitting element 2 have a circular cross-section at an aperture in the first side 2a. The holes 2c have a continuously circular cross-sectional shape up to a stop surface 2c₁. Thereafter they have a semicircular cross-sectional shape up to an aperture on the second side 2b. Each connecting element 3 has a circular cross-sectional shape at the first end 3a and a semicircular cross-sectional shape at the second end 3c. The intermediate portion 3e has a transition between the circular cross-sectional shape and the semicircular cross-sectional shape. The transition is defined by a stop surface 3e₁.

The electrical connecting device may be fitted in the following way. The fitting element 2 is fastened in the aperture 1a of the wall element 1. The wall element has in this case an internal stop surface 1b for the fitting element 2 when the latter reaches a desired fitting position in the aperture 1a. The stop surface 1b may where appropriate be provided with a sealing means to ensure a tight connection between the fitting element and the wall element. The second ends 3c of the respective elements 3 are thereafter each inserted in a hole 2c which runs through the fitting element, via the apertures on the first side 2a. When the connecting element's second end 3c reaches the semicircular region of the hole 2c, it has to be kept in a specific rotational position to enable it to be inserted further through the hole 2c. The connecting element 3 has here to be kept in a rotational position such that its planar surface 3e₂ will be parallel with a corresponding planar surface 2c₂ which defines the hole 2c where it has a semicircular cross-sectional shape. The connecting element's first end 3c may thereafter be inserted further through the hole 2c and out on the second side 2b of the fitting element. The movement will end when the connecting element's stop surface 3e₁ reaches the hole's stop surface 2c₁. The connecting element 3 will then have reached an intended fitting position in the hole 2c. In this position the connecting element's second end 3c will protrude a suitable distance into the enclosed space defined by the wall element 1, while at the same time the connecting element's first end will be in a desired position outside the wall element 1. The planar surface 3e₂ of the connecting element and the planar surface 2c₂ which defines the hole 2c will be in contact with one another. The surfaces 2c₂, 3e₂ will thus prevent any turning of the connecting element 3. In the fitting position the connecting element may therefore neither be turned nor be inserted further in the hole 2c. The O-ring 5 will also exert compressive force on the connecting element 3 and the surrounding surfaces of the fitting element 2. The O-ring 5 will thus provide a good seal so that oil cannot leak out through the hole 2c. The compressive force of the O-ring 5 means that a certain amount of force would be required to draw the connecting element 3 back from the specific fitting position. The O-ring 5 thus also helps to keep the connecting element 3 in the specific fitting position.

Finally, the housing 4 is fastened to the wall element 1 by means of screws 6 placed in the holes 4c. The housing has an openable cover 4d which is with advantage fastened to the housing by means of undepicted screws or a suitable snap device. When the cover is in place, the housing 4 serves as a tight enclosure for the connecting element's first end 3a and connecting cable ends. The connections of the connecting device to the external electric cables may thus be protected from dirt, moisture and mechanical action.

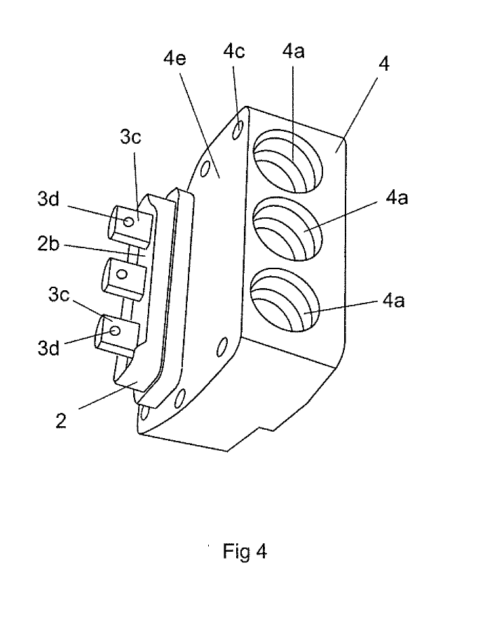

FIG. 4 depicts an alternative embodiment of the connecting device. In this case the fitting element 2 and the housing 4 constitute a preassembled unit. The housing has in this case an internal wall 4e. The connecting element 3 is thereafter fitted in the fitting element 2. In this case the connecting device may be fitted as a composite unit in an aperture 1a in a wall element 1 of an electrical machine and be fastened by means of screws placed in the holes 4c.

The invention is in no way limited to the embodiments to which the drawings refer, but may be varied freely with the scopes of the claims.

1. An electrical connecting device for a machine, which machine has a wall element (1) which separates an internal space of the machine from its surroundings, which connecting device comprises a fitting element (2) suited to being fitted in an aperture (1a) of the wall element (1), at least one connecting element (3) which has a first end (3a) with a first connection unit (3b) for an electric cable which is situated outside the wall element (1), a second end (3c) with a second connecting element (3d) for an electric cable which is situated within the internal space, and an intermediate portion (3e) suited to being fitted in a hole (2c) which runs through the fitting element (2), and a sealing means (5) suited to making a tight connection between the connecting element (3) and the fitting element (2) in the hole (2c), characterised in that the fitting element (2) is made integrally from a first material, that the connecting element (3) is made integrally from a second material and that the connecting element (3) and the fitting element (2) are provided with mutually cooperating surfaces (2c₁, 2c₂, 3e₁, 3e₂) which define a predetermined fitting position for the connecting element (3) in the hole (2c).

2. An electrical connecting device according to claim 1, characterised in that the fitting element (2) and the connecting element (3) have mutually cooperating surfaces (2c₂, 3e₂) which define a predetermined rotational position of the connecting element (3) within the hole (2c).

3. An electrical connecting device according to claim 1 or 2, characterised in that the fitting element (2) and the connecting element (3) have mutually cooperating surfaces (2c₁, 3e₁) which define a predetermined axial fitting position for the connecting element (3) within the hole (2c).

4. An electrical connecting device according to any one of the foregoing claims, characterised in that the sealing means (5) is fitted in a recess (3f) which extends round the connecting element (3).

5. An electrical connecting device according to any one of the foregoing claims, characterised in that the sealing means is an O-ring (5).

6. An electrical connecting device according to any one of the foregoing claims, characterised in that the intermediate portion (3e) of the connecting element (3) has a region with a circular cross-section and a region with a non-circular cross-section.

7. An electrical connecting device according to any one of the foregoing claims, characterised in that the connecting element's ends (3a, 3c) have connection units in the form of threaded holes (3b, 3d).

8. An electrical connecting device according to any one of the foregoing claims, characterised in that the fitting element (2) has running through it at least two holes (2c) to accommodate respective connecting elements (3).

9. An electrical connecting device according to any one of the foregoing claims, characterised in that the connecting device comprises a housing (4) which encloses the connecting element's first end (3a) and the first connection unit (3b).

10. An electrical connecting device according to claim 9, characterised in that the housing (4) and the fitting element (2) take the form of a composite unit.
